(19) United States
(12) Patent Application Publication
(10) Pub. No.: US 2008/0236214 A1
(43) Pub. Date: Oct. 2, 2008

(54) Tubular-type digital door lock with integrated driving unit-deadbolt structure

(75) Inventor: Deog Hee Han, Seoul (KR)

Correspondence Address: HARNESS, DICKEY & PIERCE, P.L.C., P.O. BOX 828, BLOOMFIELD HILLS, MI, 48303, US

(73) Assignee: IREVO, INC., Seoul (KR)

(21) Appl. No.: 12/009,159

(22) Filed: Jan. 16, 2008

(30) Foreign Application Priority Data
Mar. 30, 2007 (KR) 20-2007-0005260

(51) Int. Cl. E05B 65/06

(52) U.S. Cl. 70/129

(57) ABSTRACT

Disclosed is a tubular-type digital door lock with an integrated driving unit-deadbolt structure. The door lock includes: a driving unit having a driving motor, and a group of gears associated with a spindle of the driving motor; a shaft unit having a rotary part with gear teeth formed on the periphery thereof, and an arm extending from the rotary part; a deadbolt slider formed with a deadbolt at a side thereof, the deadbolt slider being moved in cooperation with the shaft unit; a locking detection sensor coming into contact with a side of the arm so as to determine whether the deadbolt is locked or unlocked; a main control board receiving a signal from the locking detection sensor so as to operate the driving motor; and a main body including the driving unit, the shaft unit, the locking detection sensor, and the deadbolt slider.

### BACKGROUND OF THE INVENTION

1. Field of the Invention

The present invention relates to a tubular-type digital door lock with an integrated driving unit-deadbolt structure. More particularly, the present invention relates to a tubular-type digital door lock with an integrated driving unit-deadbolt structure, wherein a driving unit consisting of a driving motor and a group of gears is provided within a main body of a conventional mechanical tubular-type door lock so as to automatically implement the locking/unlocking function of the digital door lock, wherein the driving unit is arranged coaxial to a deadbolt so as to avoid an increase of volume of the door lock even though the driving unit is added, thus reducing the manufacturing costs, and wherein a door close detection sensor is additionally provided so that the automatic locking function is performed depending on the signal from the door close detection sensor, thereby increasing the convenience to users.

2. Description of the Related Art

In general, a door is provided with a door lock so as to prevent unauthorized entry by a stranger. Conventional mechanical tubular-type door locks are typically used in Europe and America so as to minimize the damage to doors.

FIG. 1a shows a longitudinal cross-sectional view and a right side view of a conventional mechanical tubular-type door lock when it is locked, and FIG. 1b shows a longitudinal cross-sectional view and a right side view of the conventional mechanical tubular-type door lock when it is unlocked.

As shown in FIGS. 1a and 1b, a conventional mechanical tubular-type door lock includes a deadbolt 120, a lever shaft 155, and a main body 140.

The deadbolt translates between an outward extension position “A” and an inward insertion position “B” so as to perform the locking/unlocking function of a door.

That is, when the deadbolt 120 is located in the outward extension position “A” (that is, when the deadbolt is positioned within the striker of the door), the door is locked, and when the deadbolt 120 is located in the inward insertion position “B” (that is, when the deadbolt positioned outside of the striker of the door), the door is unlocked.

The lever shaft 155 consists of a rotary body 151, which is formed with a shank anchoring slot 157 at the center thereof, into which a shank (not shown) engaged in a key hole (not shown) is inserted, and an arm 153 extending from the rotary body 151.

The main body 140 is provided to be driven into the body of the door. A door boundary cover part 141 affixed to a boundary surface of the door by anchoring screws is provided on a side of the main body 140. A deadbolt body 130 is provided within the main body 140, which interconnects the lever shaft 155, the deadbolt 120, and the lever shaft 155.

The deadbolt body 130 is formed with the deadbolt 120 on one side, and a reception hole 160 on the other side, wherein the reception hole 160 is formed so as to allow the arm 153 to partially project through the reception hole 160.

The operation process of the mechanical tubular-type door lock will be described with reference to FIGS. 1a and 1b.

At first, if the user inserts a key into the key hole (not shown) and rotates the shank (not shown), which is engaged in the shank anchoring slot 157, in one direction so as to lock the door, the rotary body 151 is rotated in the one direction, and hence the arm 153 extending from the rotary body 151 is also rotated in the one direction, thereby pushing the deadbolt body 130 toward the outside of the main body 140. As a result, the deadbolt 120 is extended to the outward extension position “A,” thereby locking the door.

At this time, the deadbolt 120 having moved forward is positioned within the striker of the door lock.

If the user inserts the key into the key hole (not shown) again and rotates the shank (not shown), which is engaged in the shank anchoring slot 157, in the other direction so as to unlock the door, the rotary body 151 is rotated in the other direction, and hence the arm 153 extending from the rotary body 151 is also rotated in the other direction, thereby pulling the deadbolt body 130 toward the inside of the main body 140. As a result, the deadbolt 120 is retracted to the inward insertion position “B”, thereby unlocking the door.

Both sides of the reception hole 160 formed on the other side of the deadbolt body 130 serve as stoppers for regulating the rotating radius of the arm at the time of locking or unlocking.

Such a conventional mechanical tubular-type door lock locks or unlocks a door when the user manually rotates the lever shaft with a key so that the deadbolt is extended to the outside of the door boundary cover part or retracted to the inside of the inside of the door boundary cover part. As a result, if the user loses his or her key, it is impossible to lock or unlock the door. In addition, if the user forgets to lock the door, it is impossible to prevent unauthorized entry by a stranger.

### SUMMARY OF THE INVENTION

Accordingly, the present invention has been made to solve the above-mentioned problems occurring in the prior art, and the present invention provides a tubular-type digital door lock with an integrated driving unit-deadbolt structure, wherein a driving unit consisting of a driving motor and a group of gears is provided within a main body of a conventional mechanical tubular-type door lock so as to automatically implement the locking/unlocking function of the digital door lock, wherein the driving unit is arranged coaxial to a deadbolt so as to avoid an increase of volume of the door lock even though the driving unit is added, thus reducing the manufacturing costs, and wherein a door close detection sensor is additionally provided so that the automatic locking function is performed depending on the signal from the door close detection sensor, thereby increasing the convenience to users.

According to an aspect of the present invention, there is provided a tubular-type digital door lock with an integrated driving unit-deadbolt structure including: a driving unit having a driving motor, and a group of gears associated with a spindle of the driving motor; a shaft unit having a rotary part with gear teeth formed on the periphery thereof, and an arm extending from the rotary part; a deadbolt slider formed with a deadbolt at a side thereof, the deadbolt slider being moved in cooperation with the shaft unit; a locking detection sensor coming into contact with a side of the arm so as to determine whether the deadbolt is locked or unlocked; a main control board receiving a signal from the locking detection sensor so as to operate the driving motor; and a main body including the driving unit, the shaft unit, the locking detection sensor, and the deadbolt slider.

### BRIEF DESCRIPTION OF THE DRAWINGS

The above and other objects, features and advantages of the present invention will be more apparent from the following detailed description taken in conjunction with the accompanying drawings, in which:

FIG. 1a shows a longitudinal cross-sectional view and a side view of a conventional mechanical tubular-type door lock when it is locked;

FIG. 1b shows a longitudinal cross-sectional view and a side view of the conventional mechanical tubular-type door lock when it is unlocked;

FIG. 2 shows a side view illustrating a tubular-type digital door lock with a driving unit and a deadbolt integrated with each other according to an embodiment of the present invention in a state in which the door lock is mounted in a door;

FIG. 3 shows a longitudinal cross-sectional view and a side view illustrating the internal construction of the tubular-type digital door lock of FIG. 2;

FIG. 4a shows a longitudinal cross-sectional view of the tubular-type digital door lock of FIGS. 2 and 3 when it is locked;

FIG. 4b shows a longitudinal cross-sectional view of the tubular-type digital door lock of FIGS. 2 and 3 when it is unlocked;

FIG. 5a shows a perspective view of the tubular-type digital door lock of FIGS. 2 and 3;

FIG. 5b shows an enlarged perspective view of the inner side of the part indicated by a circle “C” in FIG. 5a; and

FIGS. 6a and 6b show perspective views illustrating a deadbolt slider and a deadbolt, which are provided within the tubular-type digital door lock of FIGS. 2, 3 and 5a, in a normal position and in an inverted position, respectively.

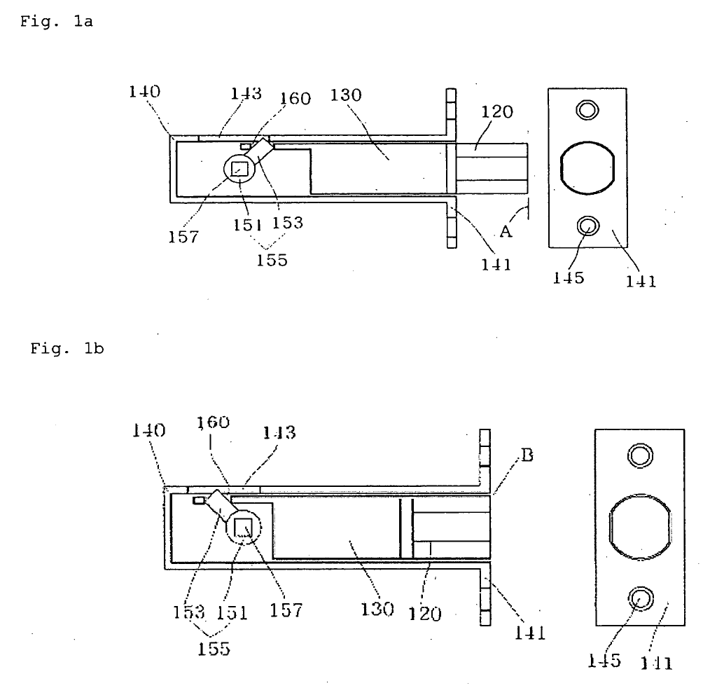

### DETAILED DESCRIPTION OF THE EXEMPLARY EMBODIMENT

Hereinafter, the exemplary embodiment of the present-invention will be described with reference to the accompanying drawings. It should be noted that in the following description, the same elements will be designated by the same reference numerals even though they are shown in different drawings. In addition, in the following description of the present invention, a detailed description of known functions and configurations incorporated herein will be omitted when it may make the subject matter of the present invention rather unclear.

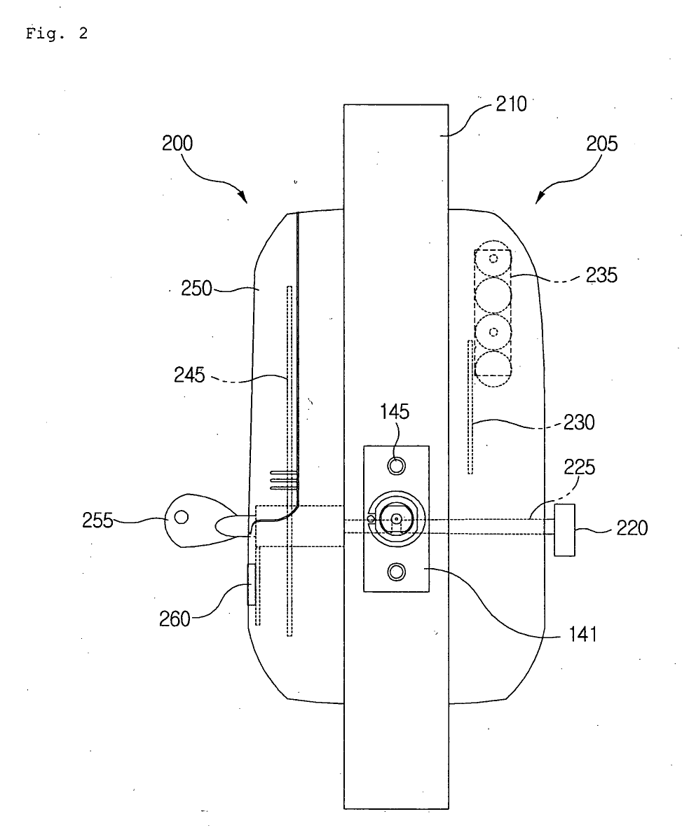

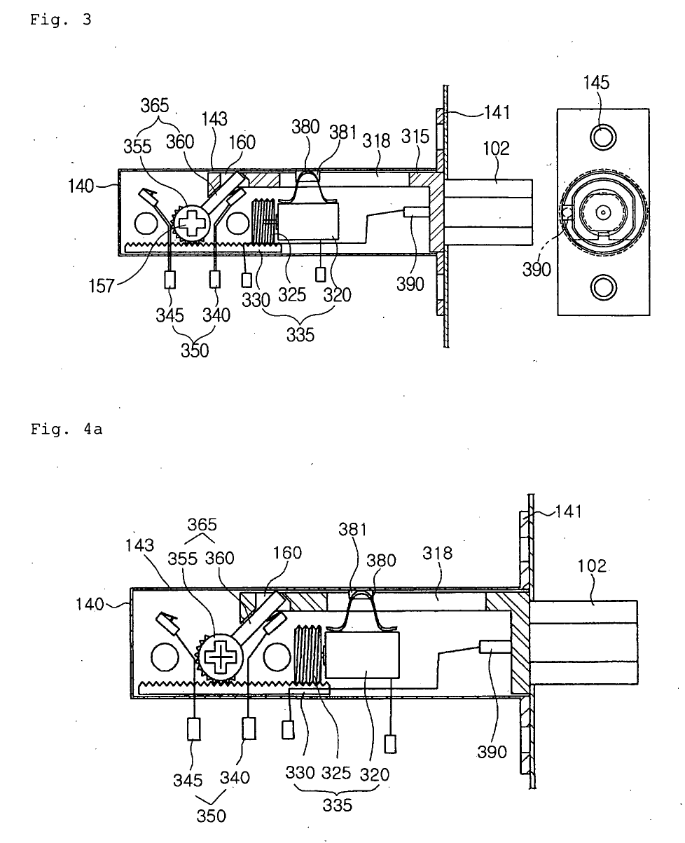

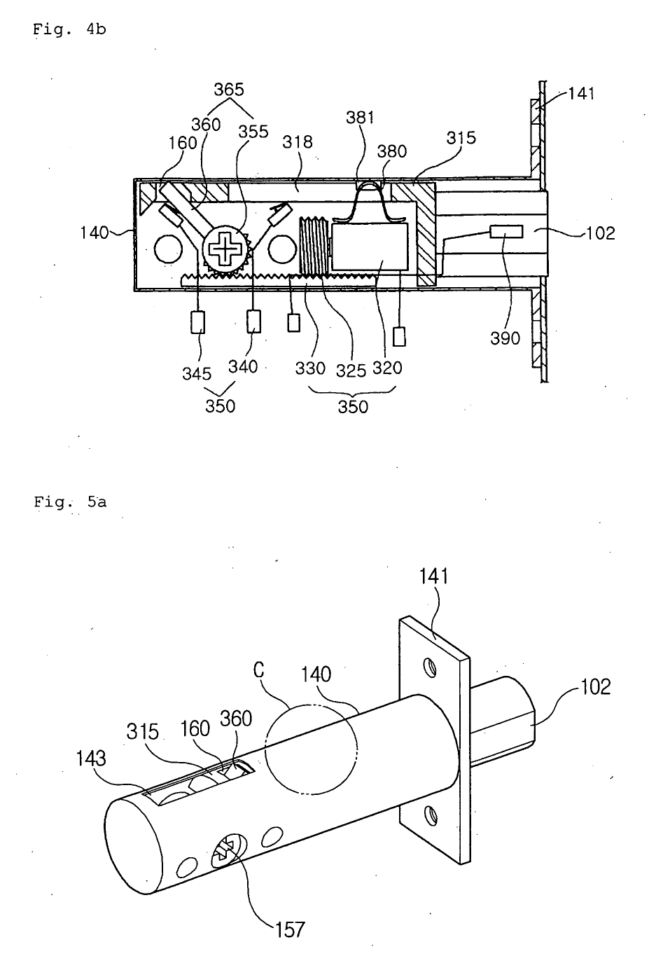

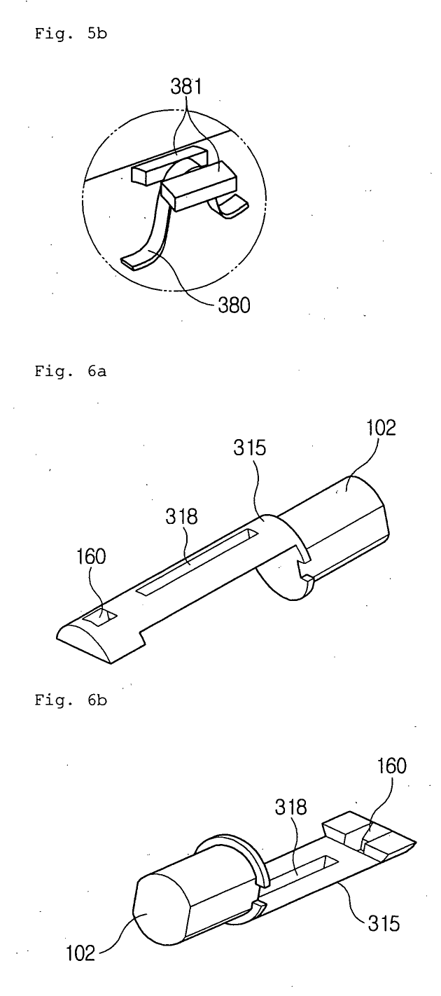

FIG. 2 shows a side view showing a tubular-type digital door lock with a driving unit and a deadbolt integrated with each other according to an embodiment of the present invention in a state in which the door lock is mounted in a door, and FIG. 3 shows a longitudinal cross-sectional view and a side view showing the internal construction of the tubular-type digital door lock of FIG. 2. In addition, FIG. 4a shows a longitudinal cross-sectional view of the tubular-type digital door lock of FIGS. 2 and 3 when, it is locked, and FIG. 4b show a longitudinal cross-sectional view of the tubular-type digital door lock of FIGS. 2 and 3 when it is unlocked. Furthermore, FIG. 5a shows a perspective view of the tubular-type digital door lock of FIGS. 2 and 3, and FIG. 5b show an enlarged perspective view of the inner side of the part indicated by ‘C’ in FIG. 5a. Finally, FIGS. 6a and 6b are perspective view showing a deadbolt slider and a deadbolt in the tubular-type digital door lock of FIGS. 2, 3 and 5a, in a normal position and in an inverted position, respectively.

As shown in FIGS. 2 to 6b, the inventive door lock includes a driving unit 335, a shaft unit 365, a locking detection sensor 350, a main control board 230, a deadbolt slider 315, and a main body 140. The inventive door lock further includes a driving motor 320, an elastic member 380 provided on a side of the driving motor 320, and a door close detection sensor 390 provided on a side of the main body 140 so as to send a door close signal to the main control board 230.

In addition, an outdoor mounting part 200 is provided with a front control board 245, which receives signals from a numerical keypad (not shown) and an authentication unit, and determines whether the signals are effective input signals or not so as to control the driving unit 335. The outdoor mounting part 200 is also provided with an override key 255 cooperating with the shaft unit 365 so as to lock or unlock the door 210.

In addition, there is also provided a front cover 250 which is capable of covering the above-mentioned numerical keypad (not shown), the above-mentioned authentication unit 260, etc., so as to normally prevent these components from being exposed to the outside, and to prevent foreign matter, such as dust, from being deposited to these components.

On an indoor mounting part 205 of the inventive door lock, there are provided a battery unit 235 for receiving one or more batteries for supplying electric power to the driving unit 335, a manually operated handle 220, called a “thumb turn,” which is connected with a rotary part 355 on the shaft unit 365 via the shaft 225, and the main control board 230 for controlling the operation of the driving unit 335 on the basis of signals received from the locking detection sensor 350 and the door close detection sensor 390.

The door boundary cover part 141 is formed in a plate shape of a predetermined thickness. Anchoring screws 145 are provided at both ends of the door boundary cover part 141 so as to affix the main body 140 to the door 210.

The main body 140 extends from the door boundary cover part 141 and is driven into the body of the door 210, wherein the driving unit 335, the shaft unit 365, the locking detection sensor 350, the deadbolt slider 315, etc. are received within the main body 140.

The driving unit 335 includes a driving motor 320, and a group of gears 325 and 330 associated with a spindle of the driving motor 320. Preferably, the group of gears 325 and 330 include a worm gear 325 provided on the spindle of the driving motor 325, and a rack gear 330 meshing with the worm gear 325. Alternatively, the group of gears may include two or more bevel gears. Hereinafter, the group of gears 325 and 330 will be described with reference to a worm gear 325 and a rack gear 330.

The driving motor 320 may be affixed to the main body 140 via a rib, and the elastic 380 may be additionally provided on a side of the driving motor 320.

As shown in FIGS. 3 and 5b, the top of the elastic member 380 is fixedly inserted between two stoppers 381 which are oppositely formed on an internal side wall of the main body 140, and the lower part 380 of the elastic member 380 elastically supports the top of the driving motor 320, whereby the elastic member 380 can be fixed between the main body 140 and the driving motor 320.

At this time, the distance between the stoppers 381 can be properly determined, depending on the thickness of the elastic member 380.

The elastic member 380 can prevent the movement of the driving motor 320, which may occur due to rotational torque applied to the worm gear 325 when a user manually rotates the manually operated handle 220 in one direction, and hence the rack gear 330 is moved in one direction in cooperation with the rotary part 355. That is, the elastic member 380 serves to render the driving motor 320 stably maintained within the main body 140 without being moved by external force.

A wire spring with a predetermined thickness may be preferably but not exclusively employed as the elastic member 380. It is possible to employ any other material as the elastic member 380 if the material is capable of providing elastic force suitable for the driving motor 320 when provided on a side of the driving motor 320.

The shaft unit 365 includes the above-mentioned rotary part 355 and an arm 360 extending from the rotary part 355.

The shaft unit 365 receives driving force from the driving motor 320 and renders the deadbolt slider 315 to be moved into or out of the main body 140.

The rotary part 355 rotates about a shank (not shown) engaged in the shank anchoring slot 157, wherein the rotary part 355 has gear teeth formed on the periphery thereof over a predetermined circumferential area, so that the gear teeth mate with the rack gear 330, and the shaft 255 is connected to the center of the rotary part 355, so that the rotary part 355 receives torque directly from the manually operated handle 220.

The gear teeth formed on the periphery of the rotary part 355 are preferably formed over such an area that the rotary part 355 is capable of continuously receiving torque from the driving unit 355 when the arm 360 is rotated between the locking sensor 340 and the unlocking sensor 345.

One end of the arm formed on the rotary part 355 is inserted into a reception hole 160 formed on the deadbolt slider 315.

One side of the reception hole 160 comes into contact with the end of the arm 360 when the inventive tubular-type digital door lock is locked, thereby preventing the deadbolt slider 315 from entering into the main body 140 again.

The locking detection sensor 350 consists of an unlocking sensor 345 and a locking sensor 340, which come into contact with the opposite sides of the arm 360, respectively, so as to determine whether the deadbolt 102 is in a locked state or unlocked state.

Here, the “locked state” means the state in which the deadbolt 102 is moved forward to project to the outside of the main body 140 (the state in which the deadbolt 102 is pushed into the striker), and the “unlocked state” means the state in which the deadbolt 102 is retracted into the main body 140 (the state in which the deadbolt 102 is pulled out of the striker).

That is, if the rotary part 355 is rotated in one direction, the arm 360 rotating in the same direction renders the deadbolt slider 315 to be pushed into the main body 140. Then, if the one side of the arm 360 comes into contact with the unlocking sensor 345, a signal produced at that time is sent to the main control board 230, thereby stopping the operation of the driving motor 320.

To the contrary, if the rotary part 355 is rotated in the other direction, the arm 360 rotating in the same direction renders the deadbolt slider 315 to be moved toward the outside of the main body 140. Then, if the other side of the arm 360 comes into contact with the locking sensor 340, a signal produced at that time is sent to the main control board 230, thereby stopping the operation of the driving motor 320.

Preferably, the locking detection sensor 350 is affixed to the main body 140 by a rib.

In the present invention, the locking detection sensor 350 is provided within the main body 140. However, it is also possible to provide the locking detection sensor 350 on the shaft 255 or on the manually operated handle 220 because the shaft 255 and the manually operated handle 220 connected with the rotary part 355 are also rotated when the rotary part 355 is rotated.

The deadbolt slider 315 has a deadbolt 102 formed at one end thereof. The deadbolt slider 315 is moved in cooperation with the shaft unit 365, thereby determining whether the tubular-type digital door lock is in a locked or unlocked state.

The deadbolt slider 315 may be formed in a box shape with a predetermined width, and three or more sides thereof may be opened as shown in FIG. 3.

Here, the three sides include the left side, the rear side, and the bottom side. The right side may be also opened.

Therefore, the driving unit 335, the shaft unit 365, and the locking detection sensor 350 are capable of being introduced into the deadbolt slider 315 through the opened left, rear and bottom sides of the deadbolt slider 315 when the deadbolt slider 315 moves left or right within the main body 140.

As shown in FIGS. 3, 6a and 6b, a reception hole 160, through which the end of the arm 360 may be partially exposed, is formed in the top side of the deadbolt slider 315, and a through-hole 318 is also provided, through which the elastic member 380 is allowed to extend from the main body 140 to the driving motor 320.

The through-hole 318 allows the deadbolt slider 315 to slide, even in a state where the elastic member 380 extends through the deadbolt slider 315, and the lower part of the elastic member 380 elastically and firmly supports the driving motor 320, wherein the top of the elastic member 380 is affixed to a pair of stoppers 381.

The reception hole 160 renders the end of the arm to be freely exposed to the outside of the deadbolt slider 315 as the arm 360 gradually approaches to the vertical position when the arm 360 is rotated along with the rotary part 355. In addition, because the end of the arm 360 is exposed to the outside along a main body hole 143 formed through the main body 140, the rotation of the arm can be smoothly performed.

If the end of the arm 360 is formed in such a manner that it conforms to the top of the main body 140 when it is in the vertical position, a space is formed between the end of the arm 360 and the reception hole 360 at the time of locking. As a result, the above-mentioned main body hole 143 is needed.

As described above, the driving unit 335, the shaft unit 365, the locking detection sensor 350, and the deadbolt slider 315 are received within the main body.

As shown in FIG. 5a, one side of the main body 140 is formed with a door boundary cover part 141, and a main body hole 143 with a predetermined length is formed through the top of the main body 140 so as to allow the arm 360 formed on the shaft unit 365 to be partially exposed.

In addition, a door close detection sensor 390 may be provided on the one side of the main body, wherein if the door close detection sensor 390 sends a door close signal to the main control board when the door is closed, the driving unit 335 is driven, thereby operating the shaft unit 365, so that the deadbolt slider 315 is pushed to the outside of the main body 140. As a result, the automatic locking function is implemented.

Here, the “automatic locking function” means a function performed in such a manner that when a predetermined length of time has passed after the door was closed, the shaft unit 365 is automatically rotated so that the deadbolt 120 is moved to extend to the outside of the main body 140, thereby locking the door 210.

The door close detection sensor 390 is preferably but not exclusively formed from a magnetic switch. It is possible to employ any other sensor if the sensor is capable of detecting door close when the door is closed, and sending a detection signal to the main control board 230.

FIG. 4a shows a longitudinal cross-sectional view of the tubular-type digital door lock of FIGS. 2 and 3 when it is locked, and FIG. 4b shows a longitudinal cross-sectional view of the tubular-type digital door lock of FIGS. 2 and 3 when it is unlocked.

When it is desired to lock the door, a signal is sent to the driving motor 320 from the main control board. If so, the spindle of the driving motor 320 is rotated in one direction. Then, the worm gear 325 formed on the spindle of the driving motor 320 is rotated in the same direction, so that the rack gear 330 meshing with the worm gear 325 is moved in a corresponding direction.

If so, the rotary part 355 meshing with the rack gear 330 is rotated in the one direction, and renders the arm 360 formed on the rotary part 355 to be rotated in the same direction, so that the deadbolt slider 315 cooperating with the arm 360 is moved toward the outside of the main body 140. Consequently, the deadbolt 102 projects to the outside of the door boundary close part 141, thereby locking the door (see the state shown in FIG. 4a).

At this time, the locking signal sent from the main control board may be provided by the door close detection sensor which detects whether the door is closed or not and sends a detection signal to the main control board.

To the contrary, if it is desired to unlock the door 210, an opposite signal is sent from the main control board to the driving motor 320. If so, the spindle of the driving motor 320 is rotated in the other direction, and the worm gear 325 formed on the spindle of the driving motor 320 is also rotated in the other direction. If so, the rack gear 330 is moved in a corresponding direction.

If so, the rotary part 355 meshing with the rack gear 330 is rotated in the other direction, and renders the arm 360 formed on the rotary part 355 to be rotated in the same direction, so that the deadbolt slider 315 cooperating with the arm 360 is moved into the main body 140. Consequently, the deadbolt 102 is pulled into the inside of the door boundary close part 141, thereby unlocking the door (see the state shown in FIG. 4b).

At the time of locking the door, the driving motor 320 is operated until one side of the arm 360 comes into contact with the locking sensor 340, so that the locking sensor 340 sends a signal to the main control board, which in turn sends an operation stop signal to the driving motor 320.

At the time of unlocking the door, the driving motor 320 is operated in the direction opposite to the direction at the time of locking the door until the other side of the arm 360 comes into contact with the unlocking sensor 345, so that the unlocking sensor 345 sends a signal to the main control board, which in turn sends the operation stop signal to the driving motor 320.

As described above, according to the present invention, because a driving unit consisting of a driving motor and a group of gears is provided within a main body of a conventional mechanical tubular-type door lock, it is possible to automatically implement the locking/unlocking function of a door lock, and because the driving unit is arranged coaxial to a deadbolt, it is possible to avoid an increase of volume of the door lock, even though the driving unit is added, and thus it is also possible to reduce the manufacturing costs.

In addition, if a door close detection sensor is additionally provided so that the automatic locking function is performed depending on the signal from the door close detection sensor, it is possible to increase the convenience to users.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A tubular-type digital door lock with an integrated driving unit-deadbolt structure, comprising:
a driving unit having a driving motor, and a group of gears associated with a spindle of the driving motor;
a shaft unit having a rotary part with gear teeth formed on the periphery thereof, and an arm extending from the rotary part;
a deadbolt slider formed with a deadbolt at a side thereof, the deadbolt slider being moved in cooperation with the shaft unit;
a locking detection sensor coming into contact with a side of the arm so as to determine whether the deadbolt is locked or unlocked;
a main control board receiving a signal from the locking detection sensor so as to operate the driving motor; and
a main body including the driving unit, the shaft unit, the locking detection sensor, and the deadbolt slider.

2. The tubular-type digital door lock as claimed in claim 1, wherein a reception hole is formed through the top of the deadbolt slider, one end of the arm being partially exposed.

3. The tubular-type digital door lock as claimed in claim 1, wherein three or more sides of the deadbolt slider are opened.

4. The tubular-type digital door lock as claimed in claim 1, further comprising an elastic member provided on a side of the driving motor.

5. The tubular-type digital door lock as claimed in claim 1, wherein the deadbolt slider has a through-hole formed through the top side thereof.

6. The tubular-type digital door lock as claimed in claim 4, wherein a part of the elastic member is inserted between a pair of stoppers which are oppositely formed on an inner wall of the main body.

7. The tubular-type-digital door lock as claimed in any of claims 1 to 6, further comprising a door close detection sensor provided on a side of the main body so as to send a door close signal to the main control board.

8. The tubular-type digital door lock as claimed in claim 7, wherein the door close detection sensor is a magnetic switch.

9. The tubular-type digital door lock as claimed in claim 1, wherein the group of gears consist of a worm gear provided on the spindle of the driving motor, and a rack gear meshing with the worm gear.
